(19) United States
(12) Patent Application Publication
(10) Pub. No.: US 2010/0057574 A1
(43) Pub. Date: Mar. 4, 2010

(54) BUDGET ENVELOPE CREDIT CARD

(75) Inventors: Sudeshna Banerjee, Waxhaw, NC (US); Debashis Ghosh, Charlotte, NC (US); David N. Joffe, Charlotte, NC (US); Hans Shumacher, Charlotte, NC (US); Sreedevi Gummuluri, Charlotte, NC (US); Jeff Carter, Charlotte, NC (US); Nicholas Halpern, Boston, MA (US); Dan Ariely, Durham, NC (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/199,906

(22) Filed: Aug. 28, 2008

(51) Int. Cl. G06Q 40/00; G06Q 30/00

(52) U.S. Cl. 705/14.66; 705/35

(57) ABSTRACT

Apparatus and methods for providing a budget envelope credit card are provided. An apparatus according to the invention may include a budget envelope credit card software engine and a rewards software engine that provides a reward scheme for use by the budget envelope credit card engine, the rewards scheme that defines a reward frequency.

### FIELD OF TECHNOLOGY

Aspects of the disclosure relate to budgeting credit card spending.

### BACKGROUND

There are several independent companies that provide general budget management tools and/or software but these tools are not directly connected to real time credit card spending and typically do not control spending in real time. Specifically, the credit card industry does not currently have real time budget management technology built into credit line utilization.

For example, one web site recommends that once a user has noted all his fixed expenses, he should write down his expenses that vary each month such as clothing, vacations, gifts and personal spending money. Then the site recommends that the user put these expenses under the heading: Variable. “Variable” indicates that these expenses may appear every month, but the amount could change. Thus, this site offers advice to create and manage a monthly spreadsheet. This advice, however, is disconnected from the credit card that is used for transactions. So each time a customer uses his credit card, he has to enter the amount in the spreadsheet and then compare variances. This is an inefficient and burdensome budgeting system. Furthermore, the method does not provide rewards or incentives for staying within the budget.

It would be desirable, therefore, to provide apparatus and methods for integrating budgeting tools into credit card platforms.

It would also be desirable to integrate budgeting tools into credit card platforms for real time budgeting help at the time of spending.

### SUMMARY OF THE INVENTION

It is an object of this invention to provide apparatus and methods for providing and/or receiving budget envelope credit card enrollment information for a user. The method may include providing the user access to a secured website and receiving instructions from the user to identify a plurality of budgeting categories. The method may further include providing and/or receiving budget period information and spend allocations for the plurality of budgeting categories.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of apparatus that may be used in accordance with the principles of the invention;

FIG. 2 shows an illustrative flow diagram according to the invention;

FIG. 3 shows another illustrative flow diagram according to the invention;

FIG. 4 shows another illustrative flow diagram according to the invention;

FIG. 5 shows yet another illustrative flow diagram according to the invention;

FIG. 6 shows still another illustrative flow diagram according to the invention; and

FIG. 7 shows another illustrative flow diagram according to the invention.

### DETAILED DESCRIPTION OF THE INVENTION

Systems and methods for providing a budget envelope credit card according to the invention may provide real time money management tools.

Such tools may include a technology platform where customers can enter budget categories and items each month. Each time a customer uses his credit card, a charge can be assigned to a budget category, and then can be logged in real time. The real time budget tracking engine may update transactions, preferably within seconds of purchase, against individual budget categories. The tracking engine may also update the allowable spending left in each category.

Certain embodiments of the invention can include secured web access through which a customer can log budget items as well as track spending patterns relative to the budget. The customer may be given a choice of rewards for being within budget over a predetermined period of time, as well as a choice of penalties for being over budget.

Once the budget is exceeded, some embodiments of the invention send a substantially real time notification to the customer via a mobile text, email, and/or an outbound automated phone call. The selection of the type of notification may be based on customer preference, or may be system-defined.

A real time budget management engine according to the invention may be linked to one or more of the customer's credit card accounts.

Also, aspects of the invention may include a reward suite where the customer can choose from various rewards.

A budget algorithm engine according to the invention preferably assesses past budget patterns and then automatically recommends a suite of periodic budget choices (Budget A, Budget B, Budget C, etc.) for the user. The customer can select the budget that is optimal for him in a current month.

The budget algorithm engine may also project reward paths for complying with the budget suggested by the engine. The algorithm engine can also evaluate any over budget occurrences that might occur. Furthermore, the engine can optimize allocation among categories based on past performance.

In one embodiment of the invention, the engine can optimize budget compliance by helping users to learn where and when they can save. This learning process may be based on trial and error over time. The data for this optimization of budget compliance may be obtained from the historical use of the card itself.

Consumers charged more than $2.2 trillion in purchases and cash advances on major credit cards in just the year 2007. And it has become a habit for credit card users to spend more than they have. Overall credit card debt grew by 315 percent from 1989 to 2006, according to an article in CNN. Systems and methods according to the invention may provide budgetary and spending discipline to users. Such systems and methods encourage better money management skills. Such systems and methods preferably also provide a real time budget tracking component. The systems and methods may enhance budgetary skills. Moreover, such systems and methods may instill a more prevalent consumer savings behavior.

The credit card systems and methods according to the invention may also provide customers, through a secure website, access to web-based seminars, budgeting materials and financial planning materials that aid the customers in becoming financially secure.

Also, by soliciting customers to stay within budget, the credit card offering institution may reduce the risk of delinquency and “charge off”—i.e., credit card default.

Systems and methods according to the invention may operate as follows.

Participating users may select categories, penalty and reward choices as well as over-budget notification choices in a preferably secure website. Users can also select start and end points, as well as duration, of the budget period. The duration of the budget period may be weekly, bi-weekly, monthly, quarterly and/or annually or any other suitably defined period. Alternatively, the start and end points, as well as the duration, of the budget period may be system-defined.

The rewards may also be calculated at user-defined periods or may be system-defined. For example, users can cap spending on coffee per week at $15.00, dry cleaning at $50.00, groceries at $200.00, dining out at $50.00, etc. These figures may set the threshold for activating notification, achieving rewards and/or incurring penalties.

The spending caps, or any other suitable information, may be adjusted by the system to conform to an individual's historical spending patterns.

Certain embodiments of the invention may include linking multiple cards to the same budget. In addition the rules for each of the multiple cards may be different and/or blended, or some combination of the two. For example, each credit card may have its own predetermined coffee budget, but the credit cards may share a common grocery budget and/or gas account.

In addition, the over budget warnings may be sent to only one user—e.g., the user responsible for the account—or to individual users.

The data entered can be stored and may be linked, preferably in real time, to a user's card transaction files (authorization log in files). As the customer carries on regular business, the transactions can be segregated according to the spending categories and logged against the budget in the spending categories.

When the amount of transactions in a predetermined spending category approaches the budget amount and the budget period is not yet over, the system may trigger a notification to the customer. When the budget period ends and the customer is within the spending limits set, a notification of success or other motivational notification, such as a “congratulations” message may be sent out along with reward information.

Systems and methods according to the invention may provide a real time budget management tool to users. For example, the over-budget warnings may be provided depending on the spending “trajectory” of the user. If the user is on a certain monthly budget, a spending trajectory may forecast that the user will spend a certain amount per week. A system according to the invention may preferably monitor the user's weekly spending to determine whether the user is remaining within the spending trajectory. In such an embodiment, when the system determines that the user's spending trajectory indicates that the user's spending will exceed the spending threshold, then the system can warn the user prior to the surpassing of the spending threshold. In such an embodiment, systems and methods according to the invention are preferably enhancing the user's ability to think in advance about how they want to spend their money for the remaining portion of the predetermined budget period. As such, systems and methods according to the invention may act to align the desired future with the user's actual behavior.

It should be noted that the above-mentioned description of augmenting future budget thinking may be combined with budget education material in order to give the user an even greater advantage over unforeseen budgetary events.

This concept can be extended to other associations that operate on similar premises. For example, if a law firm has a particular spending budget on client entertainment, the partners may each receive a budget pre-programmed into the credit card spending account to spend on all clients, or on each client individually.

Certain embodiments of the invention may also include a location aspect. For example, certain geographic areas, such as a geographic area associated with a shopping mall, may be considered high spending areas. When a user approaches such a high-spending area, the user's location may be identified via a Global Position System (“GPS”) resident in, for example, the user's mobile phone or PDA.

In such embodiments, the system may preferably notify and/or warn the user that he or she is entering a high spending area. Alternatively, the system may also use traversing a threshold proximity to a high spending area as a cue to send current budget status in selected categories—e.g., categories that may be associated with the high spending location—to the user. In yet another embodiment of the invention, the user may be notified of high-spending geographic areas only if the user's spending in the particular category associated with the high spending area is approaching the budgeting threshold.

In some embodiments of the invention, systems and methods may also designate a certain amount of budgeted, but not spent, funds for a savings account or for paying down a loan. Alternatively, the unspent funds may be designated for a charitable donation or other user-designated location.

With respect to penalties for overspending, systems and methods according to the invention may be user-definable or system-set. Such penalties may include a warning e-mail or automatically-generated telephone call, termination of spending with respect to the overbudget categories, termination of credit card use until the next budgeted period, and/or reducing, by the exceeded amount, the budget category allocation for the next budget cycle for the exceeded category.

In certain embodiments of the invention, the penalties may be threshold-based. For example, crossing a first spending threshold may incur a less serious penalty, such as notification, while crossing other spending thresholds of greater magnitude incur penalties of greater magnitude. Such thresholds may be determined in any suitable fashion. For example, such additional thresholds may be set at percentage increments such as 5% above the budget threshold set by the user.

In yet other embodiments of the invention, the system may provide users with cost-benefit analysis of purchases in real time. For example, as a user is in the process of charging a purchase of a dress to a credit card, the system may notify the user that the purchase will cause the spending to exceed the budget for clothing and will cost far more than the present purchase price in excess credit card interest fees. Such information may be accompanied by a visual indication and/or graphic description, which may, for example, be e-mailed to the user using a URL, of how long it will take the user to pay off the dress in view of the interest on the money loaned to the person in order to purchase the dress. The analyses underlying such a description may be based on previous user spending patterns.

The system may also present alternative financial outcomes should the user elect not to purchase the item. For example, the system may provide the user an option to transfer the funds to savings, or investments and show the user the potential savings accrued by the unspent money over a predetermined period of time. Accordingly, systems and methods according to the invention may provide a tool for real-time visualization of the trade-off between spending and saving. This tool may preferably be provided at the point of purchase.

Other tools associated with the invention may include concrete budgeting tools that translate future goals into substantive saving buckets and bucket goals as well as that set spending goals. Such tools may also establish a relationship between spending and savings buckets. These tools may also establish connections between debit and/or credit cards, deposits and investments.

In additional embodiments of the invention, a social competitive savings network may be provided, preferably on an opt-in basis. Such network may be implemented together with financial health monitoring of the network members.

In still other embodiments of the invention, the customer may be allowed to enter extra financing requests. Such financing requests may be based on unforeseen extra-budgetary expenditures. Once the customer enters a payment plan to pay for the extra financing, the budget may be updated to reflect monthly payments.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

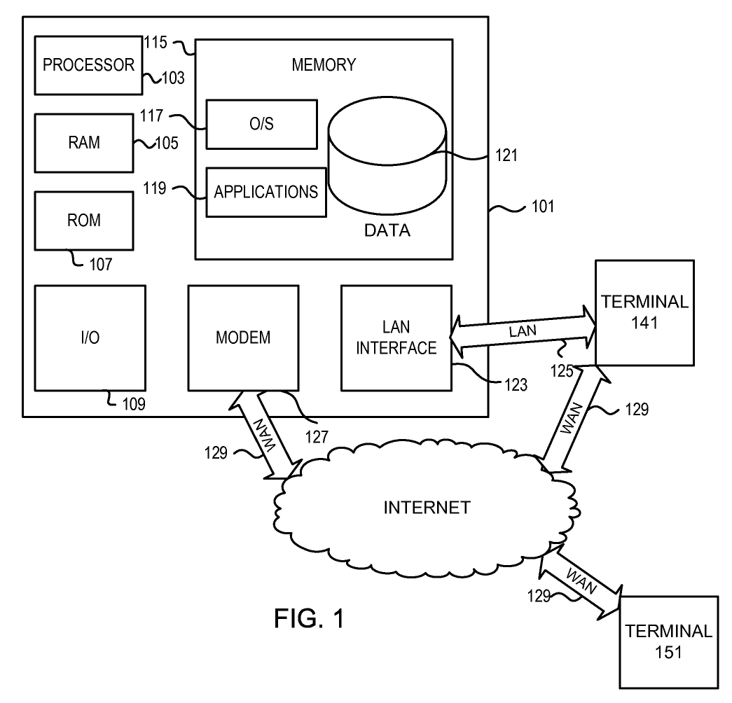

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 202 computer executable instructions may be embodied in hardware or firmware (not shown). As described in detail below, database 121 may provide storage for account information, account holder information, account application data and statistics, budget information and timing and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications. Such functionality may be used by the notification according to the invention.

Computing device 101 and/or terminals 141 or 151 may also be mobile terminals including various other components, such as a battery, speaker, and antennas (not shown).

A client of a financial institution may use a terminal such as 141 or 151 to utilize a credit card platform administered by the financial institution.

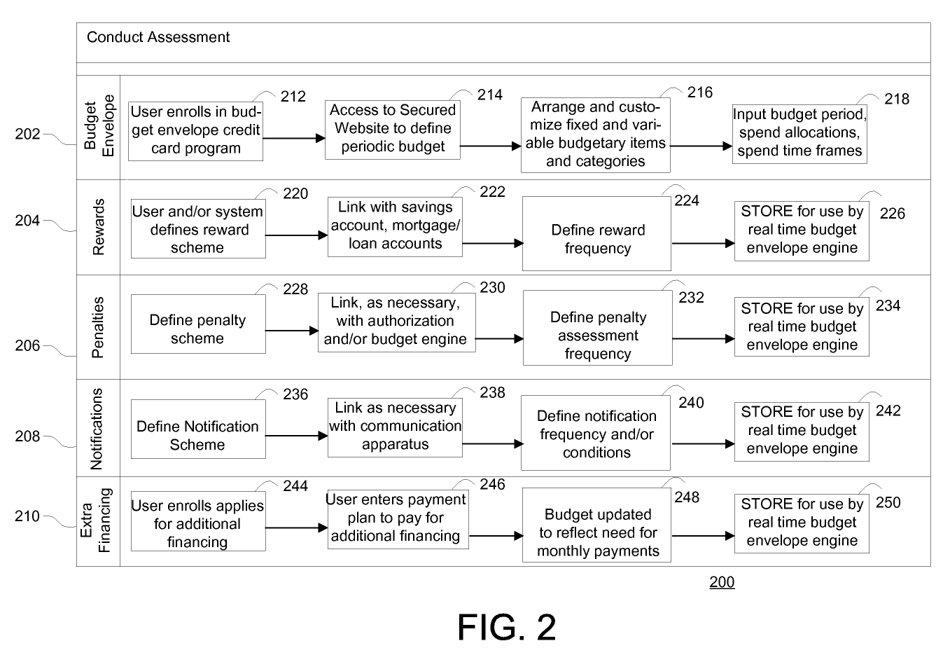

FIG. 2 shows an illustrative flow diagram according to the invention. FIG. 2 shows a conduct assessment of the various processes and systems used according to the invention.

The invention may be divided into five main processes. These process include budget envelope process 202, rewards process 204, penalties process 206, notifications process 208, and extra financing process 210.

Budget envelope process 202 includes step 212 in which the user enrolls in budget envelope credit card program. Thereafter, the user may be granted access to a secured website to define the periodic budget (at step 214). Step 216 shows arranging and customizing both fixed and variable budgetary items and categories. Step 218 shows inputting the budget period and spend allocations as well as spend time frames—i.e., the amount a user wants to spend over a given time period.

Rewards process 204 includes step 220 in which a user and/or system may define a rewards scheme. Step 222 shows linking the rewards engine of the credit card platform according to the invention with a savings account, mortgage account and/or other loan account in order to direct unspent funds to these accounts.

Step 224 shows defining, either by a user or by a system, the frequency of the rewards. Step 226 shows storing the information obtained in steps 220-224 for use by a real time budget envelope engine according to the invention.

Penalties process 206 includes defining a penalty scheme at step 228. Step 230 shows linking, as necessary, with an authorization and/or budget engine. Step 232 shows defining the penalty assessment frequency, and step 234 shows storing the information from steps 228-232 for use by the real time budget envelope engine.

Notifications process 208 include defining a notification scheme at 236 and linking, as necessary, with communication apparatus, at step 238. Such apparatus may include an e-mail generator, a telephone call generator for generating a call to a user mobile phone, or any other suitable communication apparatus.

Step 240 shows defining notification frequency and/or conditions. Step 242 shows storing the information from steps 236-240 for use by the real time budget envelope engine.

Extra financing process 210 shows the circumstance in which a user enrolls for additional financing. Such additional financing may require the user to enter a payment plan to pay for the additional financing, as shown in step 246. Step 248 shows updating the budget to reflect the need for monthly payments. Step 250 shows storing the information derived in steps 244-248 for use by the real time budget envelope engine.

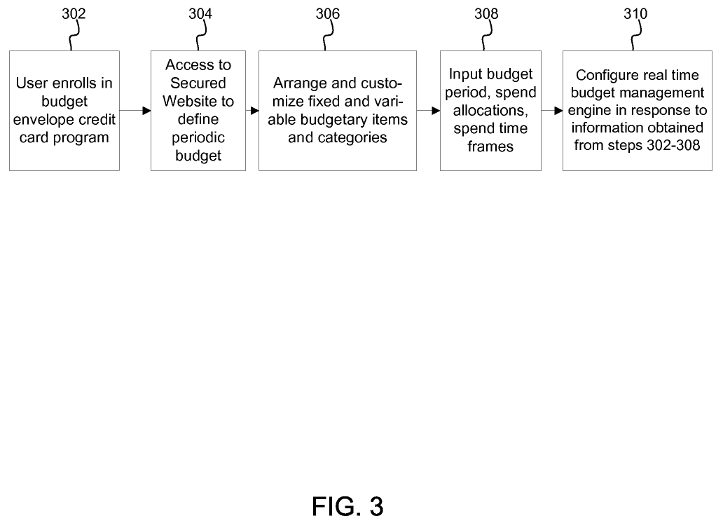

FIG. 3 shows a flow diagram according to the invention. Steps 302-308 correspond to steps 212-218 shown in FIG. 2. Step 310 shows the additional step of configuring the real time budget management engine in accordance with the information obtained from steps 302-308.

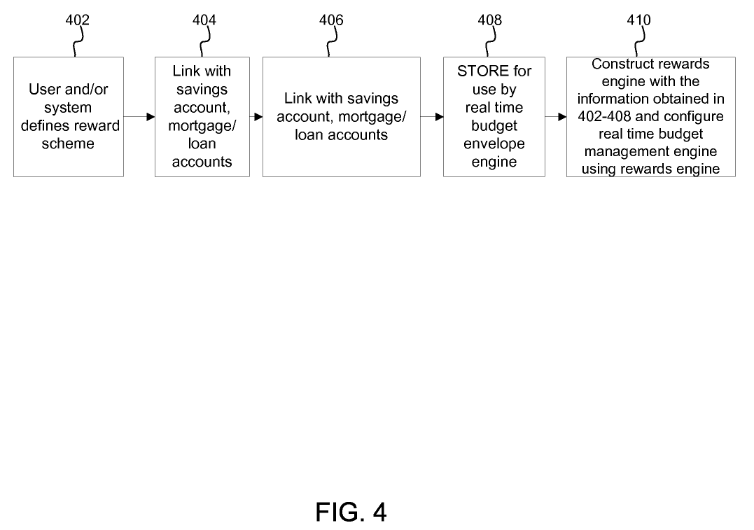

FIG. 4 shows another flow diagram according to the invention. Steps 402-408 correspond to steps 220-226 shown in FIG. 2. Step 410 shows constructing a rewards engine with the information obtained in steps 402-408 and configuring the real time budget management engine using the rewards engine.

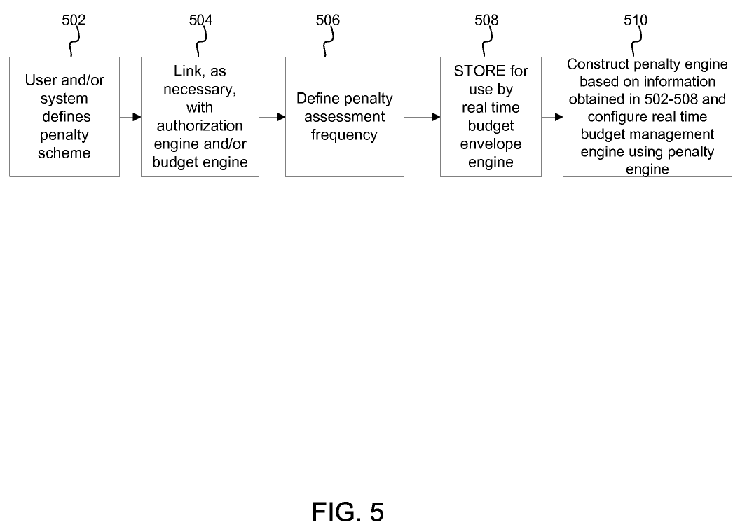

FIG. 5 shows yet another flow diagram according to the invention. Steps 502-508 correspond to steps 228-234 shown in FIG. 2. Step 510 shows constructing a penalty engine based on information obtained in 502-508 and configuring a real time budget management engine using the penalty engine.

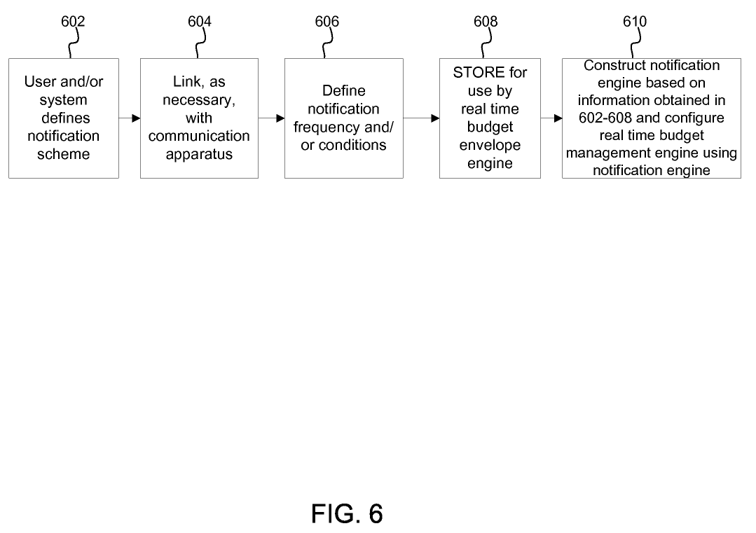

FIG. 6 shows still another flow diagram according to the invention. Steps 602-608 correspond to steps 236-242 shown in FIG. 2. Step 610 shows constructing a notification engine based on information obtained in 602-608 and configuring a real time budget management engine using the notification engine.

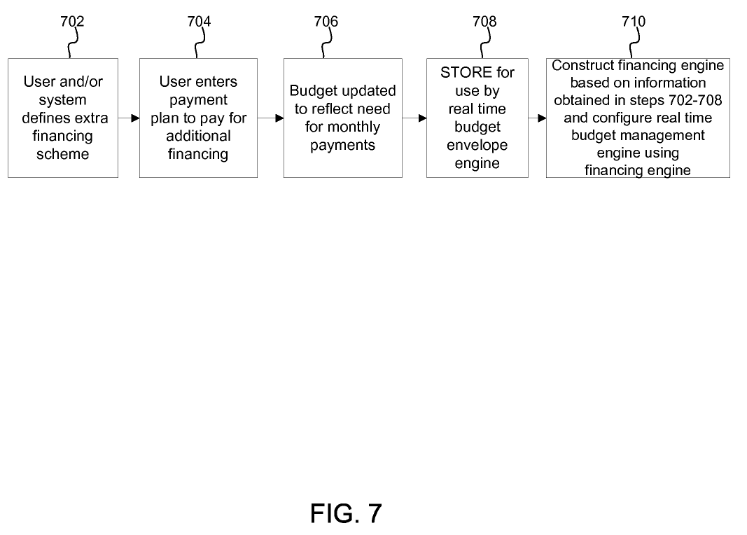

FIG. 7 shows still another flow diagram according to the invention. Steps 702-708 correspond to steps 244-250 shown in FIG. 2. Step 710 shows constructing a financing engine based on information obtained in steps 702-708 and configuring a real time budget management engine using financing engine.

Thus, FIGS. 3-7 have shown various different avenues for configuring a budget management engine according to the invention. It should be noted that the budget management engine may preferably be implemented together with a credit card platform. It should be further noted that each of the engines shown in FIGS. 3-7 may be implemented separately, or, most preferably, together in order to configure a budget management engine as implemented with a credit card platform.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, software and/or hardware engines (referred to generically herein as “engines”), objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for implementing a credit card budget envelope have been provided. Persons skilled in the art will appreciate that the present invention can be practiced by other than the described embodiments, which are presented for purposes of illustration rather than of limitation, and that the present invention is limited only by the claims that follow.

What is claimed is:

1. A method for providing a budget envelope credit card platform, the method comprising:
receiving budget envelope credit card enrollment information for a user;
providing the user access to a secured website;
receiving instructions that identify a plurality of budgeting categories; and
receiving budget period information and spending allocations for the plurality of budgeting categories.

2. The method of claim 1 further comprising receiving a definition of a reward scheme for staying within the spending allocation for a selected one of the budget categories.

3. The method of claim 2 wherein the reward scheme is user-defined.

4. The method of claim 2 wherein the reward scheme is system-defined.

5. The method of claim 2 further comprising linking the budget envelope credit card platform with one of a savings account, a mortgage loan account, and a loan account in order to execute the reward scheme.

6. The method of claim 2 further comprising receiving a definition of a reward frequency.

7. The method of claim 6 wherein the reward frequency is user-defined.

8. The method of claim 6 wherein the reward frequency is system-defined.

9. The method of claim 1 further comprising receiving a definition of a penalty scheme for exceeding the spend allocation for a selected one of the budget categories.

10. The method of claim 9 wherein the definition is user-defined.

11. The method of claim 9 wherein the definition is system-defined.

12. The method of claim 9 further comprising linking the budget envelope credit card platform with a credit card authorization engine in order to execute the penalty scheme.

13. The method of claim 9 further comprising receiving a definition of a penalty frequency.

14. The method of claim 13 wherein the penalty frequency is user-defined.

15. The method of claim 13 wherein penalty frequency is system-defined.

16. An apparatus comprising:
a budget envelope credit card software engine; and
a rewards software engine that provides a reward scheme for use by the budget envelope credit card engine, the rewards scheme that defines a reward frequency.

17. The apparatus of claim 16 further comprising a link between the budget envelope credit card engine and a savings account.

18. The apparatus of claim 16 further comprising a link between the budget envelope credit card engine and a mortgage account.

19. The apparatus of claim 16 further comprising a penalty software engine that defines a penalty scheme for use by the budget envelope credit card engine, the penalty scheme that defines a penalty assessment frequency.

20. The apparatus of claim 16 further comprising a notification software engine that defines a notification scheme for use by the budget envelope credit card engine, the notification scheme that defines a notification frequency and notification conditions.

21. A computer-readable medium storing computer-executable instructions which, when executed by a processor on a computer system, perform a method for providing a budget envelope credit card platform, the method comprising:
receiving budget envelope credit card enrollment information for a user;
providing the user access to a secured website;
receiving instructions that identify a plurality of budgeting categories; and
receiving budget period information and spending allocations for the plurality of budgeting categories.
